(19) United States
(12) Patent Application Publication
(10) Pub. No.: US 2005/0193270 A1
(43) Pub. Date: Sep. 1, 2005

(54) Mobile remote monitoring and diagnostics and method

(75) Inventors: Gregory B. Fornasiero, Powder Springs, GA (US); Christopher Joseph Degutis, Clifton Park, NY (US); Steven H. Tibbetts, Virginia Beach, VA (US); Edmund Campion, Encino, CA (US); David N. Johnson, Frenchtown, MT (US); Joseph Michael Donnelly III, Virginia Beach, VA (US); Eric Haynes, Virginia Beach, VA (US); Timothy Stoke, Virginia Beach, VA (US); Eric Pool, Virginia Beach, VA (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 10/776,207

(22) Filed: Feb. 12, 2004

(51) Int. Cl. G06F 11/00

(52) U.S. Cl. 714/39

(57) ABSTRACT

A monitoring and diagnostics system for a fleet of rental power generation equipment utilizes a plurality of remote processors each operatively engaged with a respective power generation unit. The remote processors each include a plurality of sensors detecting operating data of the respective power generation unit. A managing processor receives the operating data from the plurality of remote processors and processes the operating data via an algorithm to determine a health status of the rental power generation fleet. In one arrangement, the fleet health status is configurable for presentation via the managing processor on a single display. In another arrangement, the managing processor processes the operating data via a predictive failure algorithm to determine the health status of the power generation equipment along with a failure prediction based on the received operating data.

### BACKGROUND OF THE INVENTION

The present invention relates to power generation equipment and, more particularly, automated monitoring and diagnostics of rental power generation equipment.

Rental equipment, especially in entertainment applications, requires a high degree of security at the site precluding technicians from rapid access to the respective units. Immediate knowledge of the unit operating status is particularly important during entertainment events, during which constant power availability is critical. Remote access to unit operating data eliminates the need to bypass venue security. Also, as rental equipment is deployed globally, there is a large variation in local operator skill, potentially putting unit reliability at risk via operator inexperience.

It is known that remote monitoring and diagnostics have been used with rental equipment previously; however, none of this work is known to have included predictive failure analyses. Additionally, none of the existing systems enables monitoring and diagnostics of a fleet of rental power generation units in a single display. Predictive failure analyses have been implemented for large power applications in permanent installations. Such analyses, however, have not been used with portable equipment.

### BRIEF DESCRIPTION OF THE INVENTION

In an exemplary embodiment of the invention, a monitoring and diagnostics system is provided for a fleet of rental power generation equipment. The system includes a plurality of remote processors each operatively engaged with a respective power generation unit. Each of the remote processors includes a plurality of sensors detecting operating data of the respective power generation unit. A managing processor receives the operating data from the plurality of remote processors, and processes the operating data via an algorithm to determine a health status of the rental power generation fleet. The fleet health status is configurable for presentation via the managing processor on a single display.

In another exemplary embodiment of the invention, a method of monitoring and performing diagnostics on a fleet of rental power generation equipment includes the steps of (a) detecting operating data of the fleet of power generation equipment, the operating data being detected via a plurality of remote processors each operatively engaged with a respective power generation unit and each including a plurality of sensors; (b) receiving the operating data from the plurality of remote processors via a managing processor; (c) the managing processor processing the operating data via an algorithm; and (d) determining a health status of the rental power generation fleet, wherein the fleet health status is configurable for presentation via the managing processor on a single display.

In still another exemplary embodiment, a monitoring and diagnostics system for power generation equipment includes at least one remote processor operatively engaged with a power generation unit. The remote processor utilizes a plurality of sensors for detecting operating data of the power generation unit. A managing processor receives the operating data from the remote processor and processes the operating data via a predictive failure algorithm to determine a health status of the power generation equipment along with a failure prediction based on the received operating data.

### BRIEF DESCRIPTION OF THE DRAWINGS

FIG. 1 is a schematic illustration of a power generation equipment fleet including the mobile remote monitoring and diagnostic system of the invention; and

FIG. 2 is a flow diagram illustrating the method of the invention.

### DETAILED DESCRIPTION OF THE INVENTION

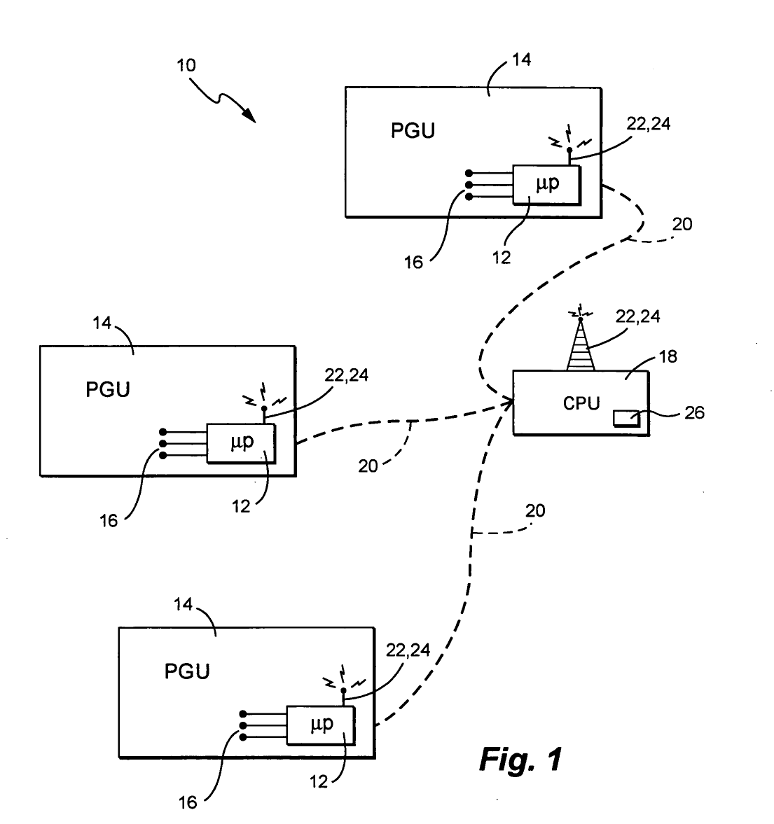

With reference to FIG. 1, the monitoring and diagnostics system 10 of the invention is particularly suited for a fleet of rental power generation equipment. The system 10 includes a plurality of remote processors 12 each operatively engaged with a respective power generation unit (PGU) 14. The remote processors 12 each include a plurality of sensors 16 for detecting operating data of the respective power generation unit 14. Such operating data may include, for example, engine speed, coolant temperature, pressure, hours of use, etc.

The remote processors 12 may be of any suitable construction comprising a CPU, a memory, input interfaces for the sensors 16, output terminals for controlling PGU 14 operation, output terminals for delivering data, and the like. One suitable remote processing apparatus is the PC6 available from SBS Technologies of Gainesville, Va.

The operating data collected by the remote processors 12 is transmitted, preferably in real time, to a managing processor 18. The data transmission may be effected by any suitable data transmission device including, for example, a wired LAN connection 20 (shown in phantom in FIG. 1), a wireless LAN 22, a cellular modem 24, or the like.

The managing processor 18 processes the operating data via an algorithm and determines a health status of the rental power generation fleet. The processor via the algorithm receives the sensor information from, for example, a diesel engine and generator. This sensor information is then processed locally and used to create baselines, alarm definitions and expert system logic to determine the health of the equipment. Any deviation from the baseline is then compared to other critical operating parameters such as, for example, the generator load in expert logic system on the generator, and the health is then logged into the system database. The system database is then transferred to a central location using cellular, satellite, or landline connection (either modem or high speed). Once determined, fleet health status is configurable for presentation via the managing processor 18 on a single display 26.

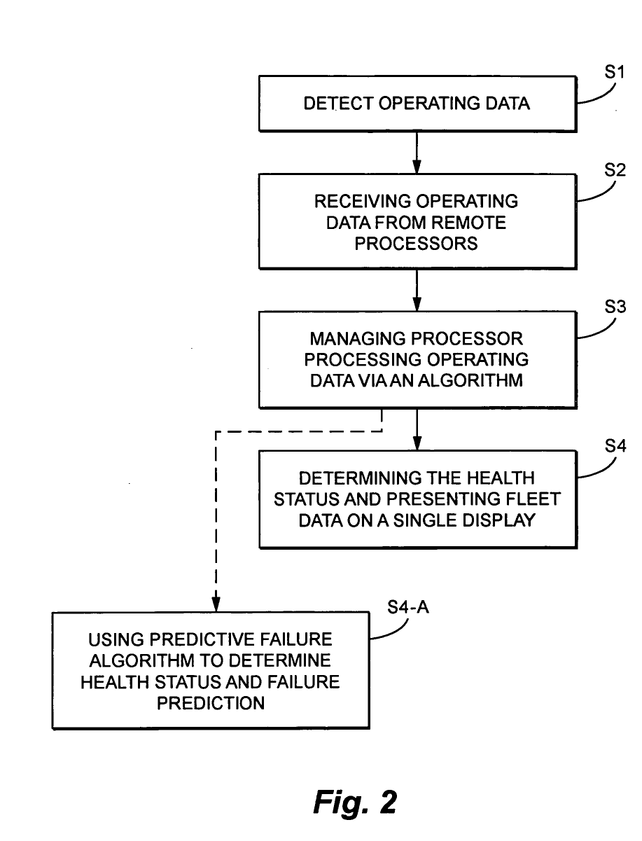

In operation, with reference to FIG. 2, in step S1, the remote processors 12 detect operating data of their respective PGUs 14. The operating data is received by the managing processor 18 from the remote processors 12 (step S2), and the managing processor 18 processes the operating data via an algorithm (step S3). Subsequently, the health status is determined and presented on a single display (step S4).

The managing processor 18 may be programmed to run a predictive failure algorithm on the operating data of a respective PGU 14 to determine health status and generate a failure prediction. Sensor information from the PGU provides inputs such as coolant temperature, oil temperature, generator load and are all trended and compared, providing real-time result that are logged to the system database. These inputs are compared in the expert system, resulting in earlier warnings and the prediction of impending failures. The results of these alarms are compared in the expert system resulting in earlier warning and prediction of impending failures. Through the use of the user notify application, operators can then be notified by either e-mail, fax, pager, etc. to allow necessary steps to be taken. (step S4-A).

With the system and method of the present invention, the operation of rental power generation equipment and the like can be automated by streaming a full suite of unit operational data to a central site. The presentation of the data on a single display facilitates management and control of the equipment while maximizing efficiency.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A monitoring and diagnostics system for a fleet of rental power generation equipment, the monitoring and diagnostics system comprising:
a plurality of remote processors each operatively engaged with a respective power generation unit, the remote processors each including a plurality of sensors detecting operating data of the respective power generation unit; and
a managing processor receiving the operating data from the plurality of remote processors, the managing processor processing the operating data via an algorithm and determining a health status of the rental power generation fleet, wherein the fleet health status is configurable for presentation via the managing processor on a single display.

2. A monitoring and diagnostics system according to claim 1, wherein the remote processors each comprise a data transmission device transmitting the operating data to the managing processor.

3. A monitoring and diagnostics system according to claim 2, wherein the respective data transmission devices transmit the operating data to the managing processor in real time.

4. A monitoring and diagnostics system according to claim 2, wherein the data transmission device comprises a wired LAN connection via a server.

5. A monitoring and diagnostics system according to claim 2, wherein the data transmission device comprises a wireless LAN connection via a server.

6. A monitoring and diagnostics system according to claim 2, wherein the data transmission device comprises a cellular modem connection via a server.

7. A monitoring and diagnostics system according to claim 1, wherein the managing processor is programmed to run a predictive failure analysis based on the operating data of each of the power generation units.

8. A monitoring and diagnostics system according to claim 1, wherein the operating data comprises at least one of engine speed, coolant temperature, pressure, and hours of use.

9. A method of monitoring and performing diagnostics on a fleet of rental power generation equipment, the method comprising:
(a) detecting operating data of the fleet of power generation equipment, the operating data being detected via a plurality of remote processors each operatively engaged with a respective power generation unit and each including a plurality of sensors;
(b) receiving the operating data from the plurality of remote processors via a managing processor;
(c) the managing processor processing the operating data via an algorithm; and
(d) determining a health status of the rental power generation fleet, wherein the fleet health status is configurable for presentation via the managing processor on a single display.

10. A method according to claim 9, wherein step (b) is practiced by transmitting, with a data transmission device for each of the remote processors, the operating data to the managing processor.

11. A method according to claim 10, wherein step (b) is further practiced in real time.

12. A method according to claim 9, further comprising the managing processor running a predictive failure analysis based on the operating data of each of the power generation units.

13. A method according to claim 9, wherein the operating data comprises at least one of engine speed, coolant temperature, pressure, and hours of use.

14. A monitoring and diagnostics system for power generation equipment, the monitoring and diagnostics system comprising:
at least one remote processor operatively engaged with a power generation unit, the remote processor including a plurality of sensors detecting operating data of the power generation unit; and
a managing processor receiving the operating data from the remote processor, the managing processor processing the operating data via a predictive failure algorithm to determine a health status of the power generation equipment along with a failure prediction based on the received operating data.
